(19) United States
(12) Patent Application Publication
(10) Pub. No.: US 2003/0221382 A1
(43) Pub. Date: Dec. 4, 2003

(54) Single-tracked window having slidable doors

(75) Inventor: Weiping Liu, Guangzhou (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Guangzhou Guangnan Keying Technologies Co., Ltd., Guangzhou (CN)

(21) Appl. No.: 10/388,317

(22) Filed: Mar. 12, 2003

(30) Foreign Application Priority Data
Mar. 13, 2002 (CN) 02226158.3

(51) Int. Cl. E06B 3/00

(52) U.S. Cl. 52/204.5

(57) ABSTRACT

A single-tracked window having slidable doors including a sash, a right door and a left door, wherein the sash comprises an upper frame and a lower fame structured with a groove of a wide groove body and a narrow opening; and each of the doors comprises an upper part, a lower part, an outside jamb and an inside jamb, wherein the inside jambs meeting at the engagement of the doors are both formed to be a wedge shape to match each other, a strip-shaped upper track and lower track respectively positioned in the upper part and lower part of each door at the same side protrude into the relative grooves of the upper frame and the lower frame of the sash, each tack of any one of the door being parallel to the corresponding one of the other door and adjacent to one side of the groove opening; a horizontal returning castor having an elastic arm and a horizontal departing castor are positioned on the front end and rear end of each upper track and lower track at the sides having wide groove body thereof; an erected supporting castor is mounted at the front end and rear end of each lower track; and guiding castors and slant guiding boards are positioned on each upper track and lower rack at the front ends thereof in the engagement between the doors along a wedges the slant guiding boards being parallel and engageable to each other.

### FIELD OF THE INVENTION

The present invention relates to a window, and more particularly, to a single-tracked window having two slidable doors, which can be superposed while opening the window by pushing one door to the other.

### BACKGROUND OF THE INVENTION

A conventional window having two slidable doors comprises an upper frame and a lower flame, in each of which two parallel guiding tracks arc formed for the two slidable doors. Each door can slide along the respective guiding track with its track and castors being supported thereon. The slidable doors will not align, but stagger and parallel to each other after closing the window, thus the window of such an undesirable structure can not meet the requirements of appearance, closure or insulation, neither is it convenient for cleaning.

### SUMMARY OF THE INVENTION

In order to solve the above problems in the conventional window, one object of the present invention is to provide a single-tracked window having two slidable doors that is of advantages, such as good appearance and insulation, and convenience for cleaning, etc.

In accordance with the first aspect of the invention, a single-tracked window having slidable doors includes a sash, a right door and a left door symmetric to the right one, wherein the sash comprises an upper frame and a lower frame structured to be a groove constituted by a wide groove body and a narrow opening; an inside jamb of the right door and that of the left door shaped as a matchable wedge are positioned at the engagement therebetween; a strip-shaped upper track and a lower rack positioned on the upper part and lower part of each door at the same side respectively protrude into the corresponding groove of the upper frame and the lower frame of the sash, each track of the right door parallel to the corresponding one of the left door being adjacent to a separate side of the groove are; a horizontal returning, castor having an elastic arm and a horizontal departing castor are positioned on the front end and rear end of the upper track and the lower back at the side having wide groove body; at the front end and rear end of the lower track is mounted an erected supporting castor; and a guiding castors and a slant guiding boards are positioned on the upper track and the lower track at the front ends thereof in the engagement between the right door and the left door along a wedge, the slant guiding boards being parallel and engageable to each other.

In accordance with the second aspect of the invention, the width of the groove openings in the said upper and said lower frames may be equal to or less than the thickness of the upper part and tie lower part for covering the groove openings to keep dust or dirt out of the groove.

In accordance with the third aspect of the invention, a downwards-slanted baffle of rubber material may be positioned at both sides of the engagement of the lower part and the lower frame for the purpose of preventing dust.

In accordance with the fourth aspect of the invention a guiding castor, a base board assembled with a guiding castor, a guiding board, a supporting castor, a departing castor and a returning castor having an elastic arm is attached to the front end of each lower track via screws, and a base board assembled with a guiding castor, a guiding board, a departing castor and a returning castor having an elastic arm is attached to the front end of each lower track via screws.

Similarly, a base board assembled with a supporting castor, a departing castor and a returning castor having an elastic arm is attached to the rear end of each lower track via screws, and a base board assembled with a departing castor and a returning castor having an elastic arm is attached to the rear end of each upper track via screws

The principle of the present invention will be described as below.

In order to open the window, force is applied to either one of the two doors along the direction opposite to the other one. With the supporting and rolling of the supporting castors, the guiding castors of either one of the doors will roll towards the other one along the guiding boards of the latter one. Meanwhile, the returning castor having an elastic arm on the front end of each track moves innerly under the pressure, so the tracks begin to overlap partly without directing contact due to the isolation and rolling of the departing castors. The guiding castors move on, the returning castor at the rear end of each track is therefore forced to the inner to make the tracks superposed completely, thus the right door superposes the left one. The window is opened. When closing the window, the door pushed to the other one previously is pulled reversely to return to its original place, then the two doors are aligned again to close the window with the elastic force of the elastic arms.

As can be seen from the above description according to the structure and the principle of the present invention, the window disclosed herein can be opened and closed smoothly and be of such advantages as tight insulation and good appearance.

### BRIEF DESCRIPTION OF THE DRAWINGS

FIG. 1 is a front view of the present invention;

FIG. 2 is a sectional view along A-A line of FIG. 1;

FIG. 3 is a sectional view along B-B line of FIG. 1;

FIG. 4 is a sectional view along C-C line of FIG. 1;

FIG. 5 is a sectional view of the tracks in an overlapped state in FIG. 4

FIG. 6 is a front view illustrating a supporting castor 12, a departing castor 13, a returning castor 15 having an elastic arm 14, a guiding castor 16 and a guiding board 17 assembled at the front end of a lower track 11 of the right door 2;

FIG. 7 is a top view of FIG. 6;

FIG. 8 is a front view illustrating a supporting castor 12′, a departing castor 13′, a returning castor 15′ having an elastic arm 14′, a guiding castor 16′ and guiding board 17′ assembled at the front end of the other lower track 11′ of the left door 2′;

FIG. 9 is a top view of FIG. 8;

FIG. 10 is a front view illustrating a supporting castor 22, a departing castor 23, a returning castor 25 having an elastic arm 24, a guiding castor 26 and a guiding board 27 assembled at the rear end of a lower track 11; and

FIG. 11 is a top view of FIG. 10.

### DETAILED DESCRIPTION OF A PREFERRED EMBODIMENT

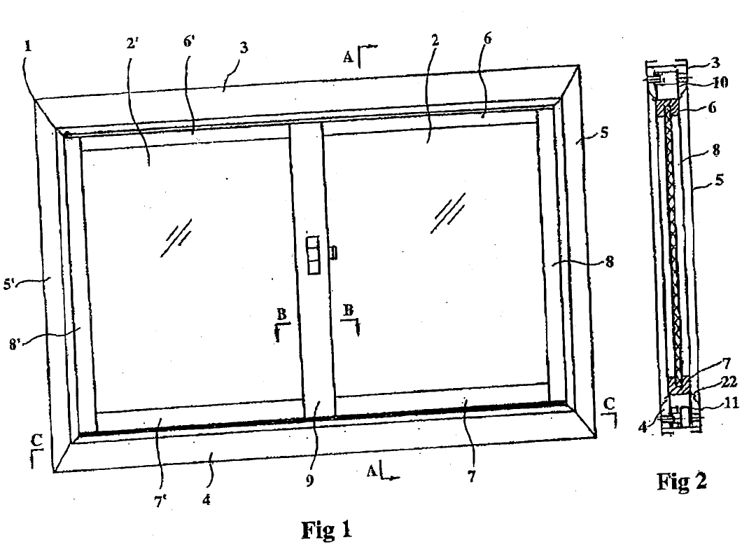

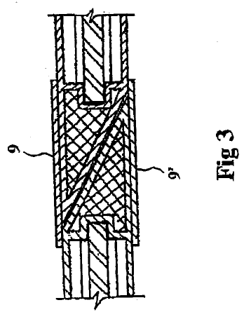

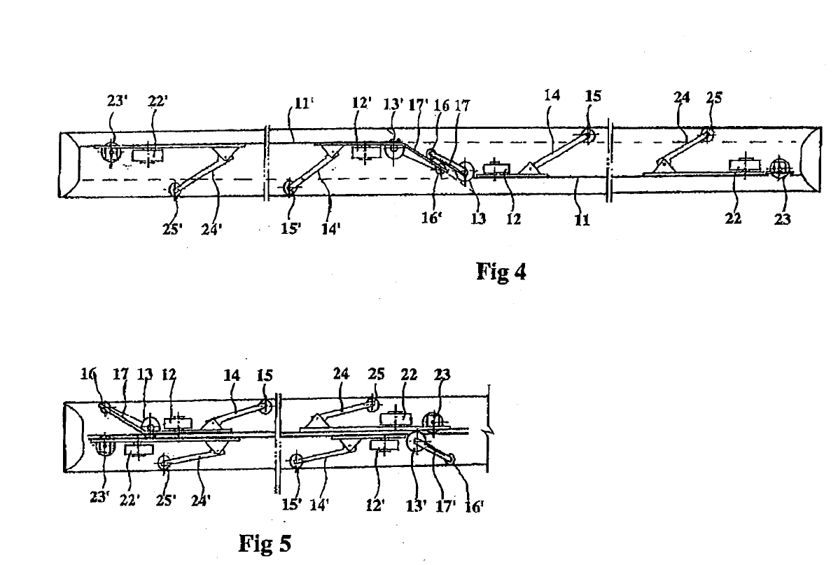

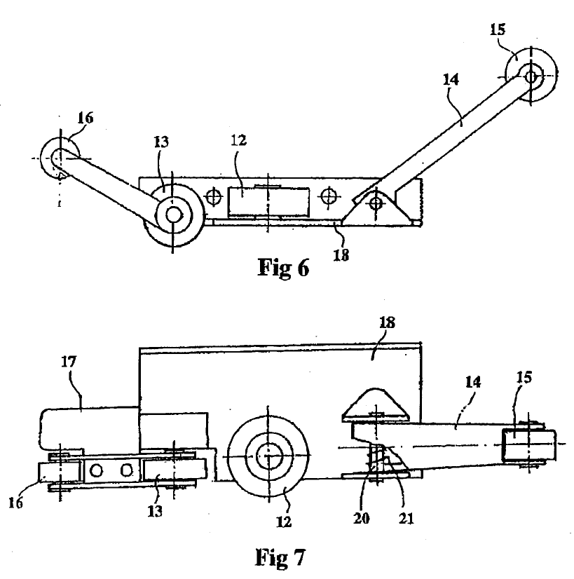

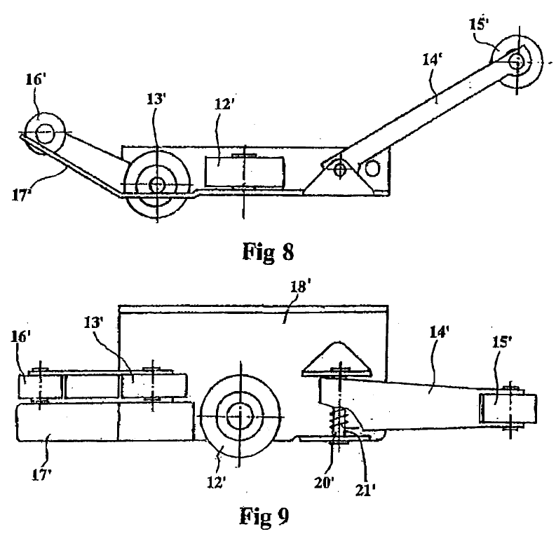

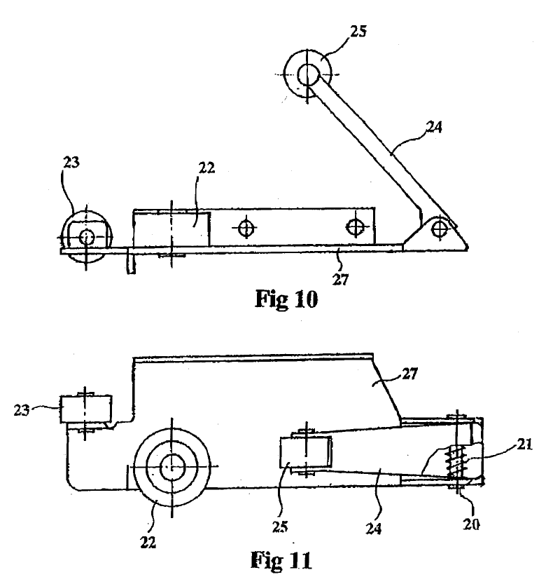

As shown in FIG. 1, the window according to the present invention comprises a sash 1 of axial symmetry and two symmetrical doors structured to be the same, i.e. a left door 2′ and a right door 2. For convenience of description, the right door 2 is explained herein in detail. The sash 1 comprising an upper frame 3, a lower frame 4 and two identical side frames 5, 5′ and the door 2 comprising an upper part 6, a lower part 7, an outside jamb 8 and an inside jamb 9 can be made from rigid material, such as aluminum alloy. The upper frame 3 and lower frame 4 are respectively shaped as a groove with a wide groove body and a narrow opening as shown in FIG. 2, the width of the opening being slightly smaller than the thickness of upper part 6 and lower part 7 of the right door 2. As shown in FIG. 3, at the engagement between the right door 2 and the left door 2′ the inside jamb 9 and 9′ are formed in a wedge shape to match each other for superposition of the two doors 2, 2′. As shown in FIG. 4, an upper track 10 and a lower track 11 are respectively positioned on the upper end of the upper part 6 and the lower end of the lower part 7 at the same side, and protrude into the groove within the upper frame 3 and the lower frame 4. Each track of the right door 2 is arranged to parallel the relevant one of the left door 2′, therefore the lower track 11 of the right door 2 and that of the left door 2′ are positioned at different sides of the groove opening in the lower frame 4, so do the upper tracks in the upper frame 3. As shown in FIGS. 6, 7, 8 and 9, a supporting castor 12, a departing castor 13, a returning castor 15 having an elastic arm 14, a guiding castor 16 and a guiding board 17 are assembled an a base board 18 which is then attached to the front end of the lower track 11 via screws. FIGS. 6, 7 and FIGS. 8, 9 illustrate respectively the right door 2 and the left door 2′ with the above-mentioned assembled parts in opposed direction. Similarly, a supporting castor 22, a departing castor 23 and a returning castor 25 having an elastic arm 24 am assembled on a base board 27 which is then attached to the rear end of the lower track 11 via screws, as shown in FIGS. 10 and 11. Unlike the lower track 11 the upper track 10 positioned in the upper part 6 comprises a guiding castor, a guiding board, a departing castor and a returning castor having an elastic arm, except a supporting castor to support the door, which are mounted on a base board which is then attached to the front end of the upper track 10 via screws. A departing castor and a returning castor having an elastic arm are mounted on the other base board to be attached to the rear end of the upper track 10 via screws. The illustrative views of the upper track 10 are omitted herein. A baffle 22, which may be made from rubber materials, slants downwards so as to be positioned at the front and back side of the engagement between the lower part 7 and the lower frame 4. As shown in FIGS. 7, 9 and 11, a twist spring 21 is positioned on a hinge 20 between the elastic arm 14 and any one of the base boards 18 and 19 in order to provide elastic force for the elastic arm 14.

The present invention can be applied to building windows and doors, and other similar devices for opening and closing purpose.

What is claimed is:

1. A single-tracked window having slidable doors including a sash, a right door and a left door, wherein
the sash comprises an upper frame and a lower frame structured with a groove of a wide groove body and a narrow opening ; and
each of the door comprises an upper part, a lower part, an outside jamb and an inside jamb, wherein
the inside jambs meeting at the engagement of the doors are both formed to be a wedge shape to match each other,
a strip-shaped upper track and lower track respectively positioned in the upper part and lower part of each door at the same side protrude into the relative grooves of the upper frame and the lower frame of the sash, each track of any one of the door being parallel to the corresponding one of the other door and adjacent to one side of the groove opening;
a horizontal returning castor having an elastic arm and a horizontal departing castor are positioned on the front end and rear end of each upper track and lower track at the sides having wide groove body thereof;
an erected supporting castor is mounted at the front end and rear end of each lower track; and
guiding castors and slant guiding boards are positioned on each upper track and lower track at the front ends thereof in the engagement between the doors along a wedge, the slant guiding boards being parallel and engageable to each other.

2. The single-tracked window having slidable doors according to claim 1, wherein the width of the groove openings of the said upper frame and lower frame are equal to or less than the thickness of the upper and the lower parts.

3. The single-tracked window having slidable doors according to claim 1, wherein a downwards-slanted baffle of rubber material is positioned at both sides of the engagement of the lower part and the lower frame of the sash for preventing dust.

4. The single-tracked window having slidable doors according to claim 1, wherein a base board assembled with a guiding castor, a guiding board, a supporting castor, a departing castor and a returning castor having an elastic arm is attached to the front end of each lower track via screws, and a base board assembled with a guiding castor, a guiding board, a departing castor and a returning castor having an elastic arm is attached to the front end of each lower track via screws.

5. The single-tracked window having slidable doors according to claim 1, wherein a base board assembled with a supporting castor, a departing castor and a returning castor having an elastic arm is attached to the rear end of each lower track via screws, and a base board assembled with a departing castor and a returning castor having an elastic arm is attached to the rear end of each upper track via screws.
